(19) United States
(12) Patent Application Publication
(10) Pub. No.: US 2020/0189811 A1
(43) Pub. Date: Jun. 18, 2020

(54) BI-DIRECTIONAL VENT

(71) Applicant: Power Packer North America, Inc., Westfield, WI (US)

(72) Inventors: Ronald Christopher Hughes, West Des Moines, IA (US); James Allen Miller, Sharpsburg, IA (US); Michael Patrick Reinsvold, West Des Moines, IA (US)

(21) Appl. No.: 16/714,268

(22) Filed: Dec. 13, 2019

Related U.S. Application Data
(60) Provisional application No. 62/779,334, filed on Dec. 13, 2018.

(51) Int. Cl. B65D 47/32; F16K 17/196; F16K 17/04

(52) U.S. Cl. CPC B65D 47/32; F16K 17/044; F16K 17/196

(57) ABSTRACT

A vent for selectively sealing an opening of an enclosed chamber includes a body, a first poppet, a second poppet, and a face seal. The body is configured to be coupled to the enclosed chamber. The first poppet is disposed within the body and is biased by a first biasing member. The first poppet includes a first surface. The second poppet is disposed within the body and includes a second surface. The second poppet is biased toward the first poppet such that the second surface is biased toward engaging the first surface. The face seal is positioned between the first surface and the second surface.

### REFERENCE TO RELATED APPLICATION

This application claims the benefit of prior-filed, co-pending U.S. Provisional Patent Application No. 62/779,334, filed Dec. 13, 2018, the entire contents of which are incorporated by reference.

### FIELD

The present disclosure relates to valves, and more specifically to a vent capable of allowing bi-directional fluid flow in response to a pressure differential.

### BACKGROUND

A bi-directional or pressure/vacuum vent may be used on a bulk container (e.g., a stackable shipping container) to regulate a pressure differential between the interior of the container and the ambient environment. The vent typically has large heights causing the portions of the vent to protrude from a surface of the bulk container, thereby increasing the risk of damage from contact by other containers or by implements for handling the containers (e.g., forks, harnesses, cables, etc.). The vent typically has a small-diameter pressure seal and permits fluid flow through one or more paths having relatively small area(s).

### SUMMARY

In one embodiment, a vent for selectively sealing an opening of an enclosed chamber includes a body, a first poppet, a second poppet, and a face seal. The body is configured to be coupled to the enclosed chamber. The first poppet is disposed within the body and is biased by a first biasing member. The first poppet includes a first surface. The second poppet is disposed within the body and includes a second surface. The second poppet is biased toward the first poppet such that the second surface is biased toward engaging the first surface. The face seal is positioned between the first surface and the second surface.

In another embodiment, a vent for selectively sealing an opening of an enclosed chamber includes a body having an upper portion and a lower portion; a cap including a seating feature having a first dimension, the cap removably coupled to the body; a poppet disposed within the body; and a biasing member engaging the seating feature and exerting a biasing force on the poppet.

In yet another aspect, a vent for selectively sealing an opening of an enclosed chamber includes a body, a poppet, and a conical spring. The body is configured to be coupled to the enclosed chamber. The poppet is disposed within the body. The poppet is movable relative to the body in response to a fluid pressure within the enclosed chamber. The conical spring is coupled to the poppet and provides a biasing force to the poppet. The conical spring is configured to compress as the poppet moves.

Other aspects of the disclosure will become apparent by consideration of the detailed description and accompanying drawings.

### BRIEF DESCRIPTION OF THE DRAWINGS

FIG. 1 is a perspective view of a vent.

FIG. 2 is a side view of the vent of FIG. 1.

FIG. 3 is a cross-sectional view of the vent of FIG. 1, viewed along section 3-3.

FIG. 4 is a cross-sectional view of a vent according to another embodiment.

FIG. 5 is a cross-sectional view of a vent according to yet another embodiment.

FIG. 6 is a cross-sectional view of a vent according to still another embodiment.

FIG. 7 is a cross-sectional view of the vent of FIG. 1, including a screen.

FIG. 8 is a cross-sectional view of a vent according to yet another embodiment.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

In general, the present disclosure relates to a vent for a container or reservoir. The vent allows fluid, such as air, to travel into or out of the container based on pressure conditions inside and outside the container.

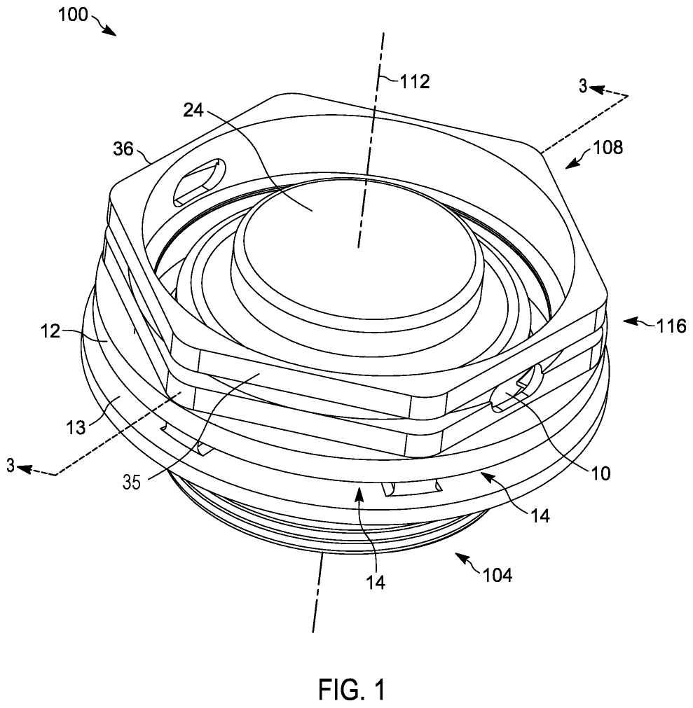

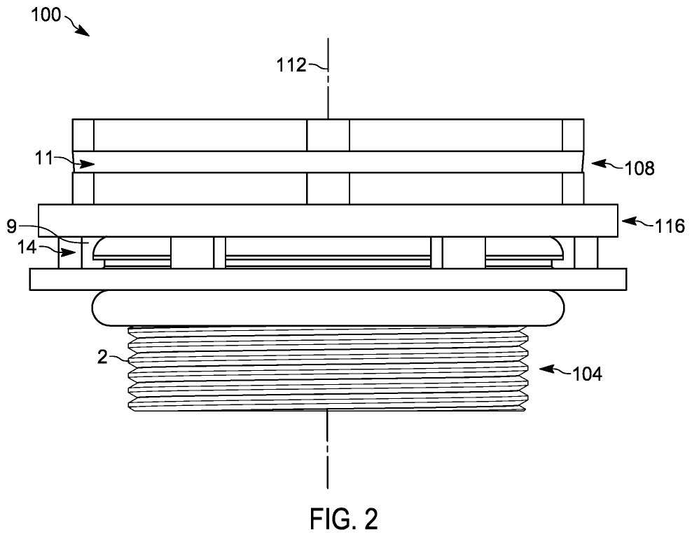

As shown in FIGS. 1 and 2, a vent 100 includes a housing 1 that can be positioned on a container, a tanker, or reservoir (not shown), such as those used in the storage of fluids. The vent 100 controls fluid flow into or out of a pressurized chamber. In the illustrated embodiment, the vent 100 maintains the internal pressure within a predetermined range relative to an ambient pressure. The vent 100 may therefore regulates an internal pressure of a space enclosed in the container in response to changes (e.g., changes in pressure caused by filling and/or emptying the container, changes in pressure caused by changes in ambient temperature, etc.).

The housing 1 has a first or lower portion 104 and a second or upper portion 108 disposed along a longitudinal axis 112. The lower portion 104 is positioned at least partially in an opening (not shown) in a wall of a container (not shown). In the illustrated embodiment, the lower portion 104 is cylindrical in shape and has a smaller diameter than the upper portion 108, and the lower portion 104 includes external threads 2 (FIG. 2) for engaging the opening. The upper portion 108 includes an outer wall 36. In the illustrated embodiment, the outer wall 36 has a polygonal (e.g., hexagonal) profile having flat side surfaces 35. A channel 11 extends around the perimeter of the upper portion 108. In the illustrated embodiment, the channel 11 has a circular shape and has a width that is less than a width of the polygonal profile of the outer wall 36.

A container (not shown) includes an opening that is generally cylindrical in shape and includes threads along an internal surface. The external threads 2 of the lower portion 104 engage the threads of the opening to couple the vent 100 to the opening. In the illustrated embodiment, a seal 3 is positioned adjacent the external threads 2 and proximate the intermediate portion 116. The seal 3 prevents fluid from traveling through the opening between the external surface of the vent 100 and the internal surface of the opening. When the vent 100 is coupled to the container, the intermediate portion 116 and the upper portion 108 may protrude from the surface of the container, permitting a tool (e.g., a wrench) to engage the flat surfaces 35 when coupling or uncoupling the vent 100 and the container.

In the illustrated embodiment, the outer wall 36 is open at an upper end (i.e., the end opposite the lower portion 104) and extends around a hollow center portion. Slots 10 extend through the outer wall 36 and into the hollow center portion. The vent 100 includes two slots 10 that are disposed opposite one another so that a common axis extends through both slots 10. In some embodiments, the outer wall 36 may include fewer or more slots, and/or the slots may be positioned in a different manner. The slots 10 can provide an egress path for liquid (e.g., rain water) that might otherwise collect within the upper portion 108. A seal (e.g., a tamper evident seal—not shown) may be attached to the slots 10.

As shown in FIG. 2, a third or intermediate portion 116 is disposed between the lower and upper portions 104, 108 along the longitudinal axis 112. In the illustrated embodiment, the intermediate portion 116 is wider than both the lower and upper portions 104, 108. Windows 9 are positioned around a perimeter of the intermediate portion 116.

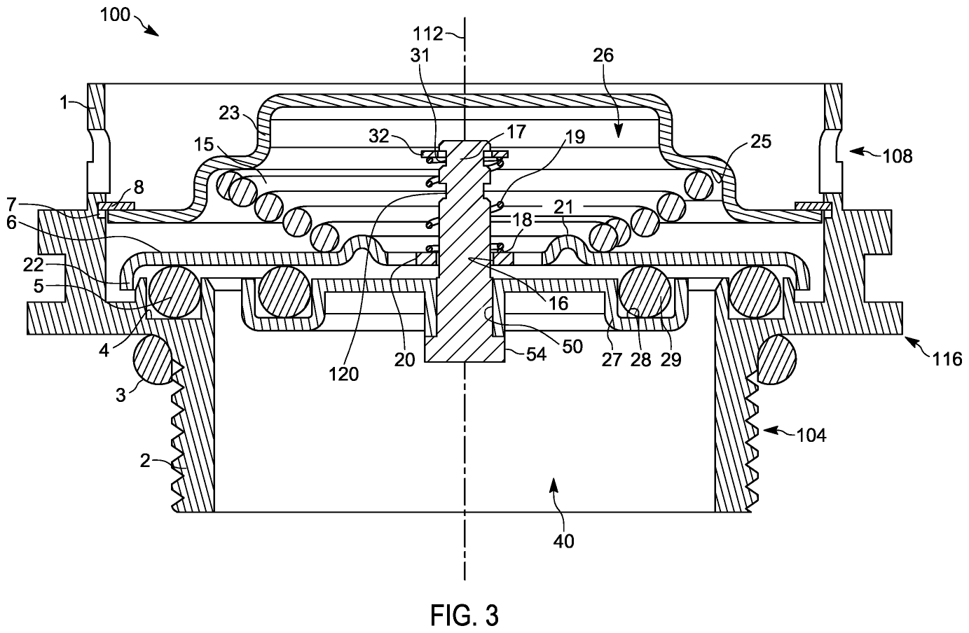

As shown in FIG. 3, the lower portion 104 of the vent 100 includes an interior space 40. A cover 23 is disposed within the hollow center portion. The cover 23 retains the components of the vent 100 and limits the intrusion of dust, debris, and other contaminants into the interior space 40. In the illustrated embodiment, the cover 23 does not extend beyond the upper portion 108. A retaining ring 8 is positioned within a groove 7 that is disposed along a perimeter of an inner surface, and the retaining ring 8 engages an upper surface of the cover 23. A cavity or pocket 26 is positioned in the cover 23 and defines an internal space.

A first poppet or pressure poppet 6 and a second poppet or vacuum poppet 27 are disposed within the housing 1. In the illustrated embodiment, the pressure poppet 6 is disposed between the vacuum poppet 27 and the upper end (i.e., the pressure poppet 6 is disposed proximate the upper housing 108 and the vacuum poppet 27 is disposed proximate the lower housing 104), and the pressure poppet 6 extends across a width of the lower housing 104.

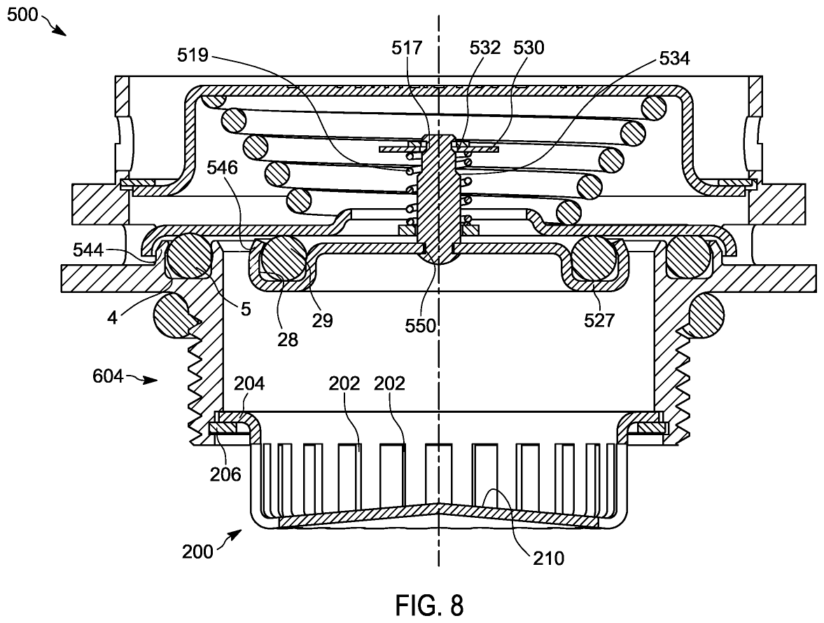

The vent 100 includes a groove 4 that extends around a perimeter of the intermediate portion 116. A first seal 5 (e.g., an O-ring) rests within the groove 4. In the illustrated embodiment, the walls of the groove are generally straight; in some embodiments (e.g., see FIG. 8), the groove 4 may be a half-dovetail groove in which an upper edge of at least one of the groove walls has a lip 544 to further ensure retention of the seal 5. The pressure poppet 6 engages the first seal 5. In the illustrated embodiment, the pressure poppet 6 includes a first or inner hole 16 and second or outer holes 20. The inner hole 16 extends through the pressure poppet 6 parallel to the longitudinal axis 112, and the outer holes 20 are positioned partly around the inner hole 16. A seat 18 is disposed between the inner hole 16 and the outer hole 20.

In the illustrated embodiment, the pressure poppet 6 is generally flat and includes a barrier 21 and a lip 22. The barrier 21 is disposed on an upper surface of the pressure poppet 6 (i.e., proximate the upper portion 108 of the vent 100). In the illustrated embodiment, the barrier 21 is an indentation disposed adjacent to and extending around a perimeter of each outer hole 20. The lip 22 is disposed at circumference peripheral edge of the pressure poppet 6 and protrudes axially toward the lower portion 104. In the illustrated embodiment, the peripheral edge overlaps an edge of the groove 4 while the pressure poppet 6 engages the first seal 5.

A first or pressure spring 15 is disposed in at least a portion of the pocket 26 of the cover 23. In the illustrated embodiment, the pressure spring 15 is wider proximate the upper portion 108. The pressure spring 15 is positioned between a seat 25 of the cover 23 and the pressure poppet 6. In the illustrated embodiment, an end of the pressure spring 15 engages an outer portion of the barrier 21, and the seat 25 and the barrier 21 assist in maintaining alignment of the pressure spring 15 and the pressure poppet 6. The pressure spring 15 can be a spring having a relatively low stiffness. In the illustrated embodiment, the pressure spring 15 is a conical spring, providing a flow area between the coils that exceeds the flow area through the vacuum valve at all levels of compression of the spring 15, even when the spring 15 is completely compressed (i.e., in a flat condition). For example, when the pressure spring 15 is completely compressed, the thickness of the spring wire multiplied by the number of coils is less than the difference between the spring outer diameter and the spring inner diameter by a predetermined clearance to ensure a minimum flow area. In other embodiments, an additional flow path may be provided in the cover around the seat.

The vacuum poppet 27 is positioned between the pressure poppet 6 and the end adjacent the lower portion 104. In the illustrated embodiment, the vacuum poppet 27 has a diameter less than a diameter of the interior space 40. The vacuum poppet 27 includes an annular groove 28 and a second seal 29 (e.g., an O-ring) is positioned within the groove 28. In the illustrated embodiment, the walls of the annular groove 28 are generally straight; in some embodiments (e.g., see FIG. 8), the annular groove 28 may be a half-dovetail groove in which an upper edge of at least one of the groove walls has a lip 546 to further ensure retention of the second seal 29. The second seal 29 engages a surface of the pressure poppet 6 during steady state (i.e., absent any pressure differential).

As shown in FIG. 3, the vacuum poppet 27 also includes a through hole 50 that is aligned with the inner hole 16 of the pressure poppet 6. A vacuum pin 17 extends through the through hole 50 and the inner hole 16, connecting the pressure poppet 6 and the vacuum poppet 27. In some embodiments the vacuum pin 17 is press fit with respect to the through hole 50. A lower end of the vacuum pin 17 includes a flanged portion 54 that engages an edge of the through hole 50. An upper end of the vacuum pin 17 includes a first slot 31 and a second slot 120, and a retaining clip 32 engages the first slot 31.

A second or vacuum spring 19 is positioned around the vacuum pin 17. In the illustrated embodiment, the vacuum spring 19 extends between the seat 18 and the retaining clip 32 disposed within the first slot 31. The retaining clip 32 sets a fixed minimum height (i.e., maximum compression) for the vacuum spring 19. The retaining clip 32 can be positioned in the first slot 31 or the second slot 120, thereby permitting adjustment of the compression of the vacuum spring 19 and the spring's biasing force. Positioning the retaining clip 32 also permits adjustment of the vacuum poppet's cracking pressure, or the pressure at which the vacuum poppet 27 initially becomes unseated. In some embodiments, the biasing force of the vacuum spring 19 is set to be greater than the product of the combined mass of the poppet 27 and the vacuum pin 17 multiplied by the expected shock load (e.g., caused by movement of a container over a rough road) in order to reduce the likelihood that the vent will open inadvertently. The pocket 26 spaces the cover 23 from the vacuum pin 17 and can inhibit manual actuation of the vacuum poppet 27.

In some embodiments, the vent 100 may include a coating along an inner surface of the lower portion 104, and along surfaces of the poppets 6, 27 and the vacuum pin 17 that face the lower portion 104. The coating may be a hydrophobic (e.g., SuperHydrophobic) and/or an oleophobic coating, either of which reduce adhesion from the contents of the container on surfaces of the vent 100. The coating enables the surfaces of the vent 100 to be cleaned without completely disassembling the vent 100, which reduces cross contamination if the contents of the container are switched, or if the vent 100 is switched between containers.

In some embodiments, a colored band or O-ring (not shown) may be placed around the channel 11. The colored band can provided identifying features for the vent 100. For example, the band could be used to communicate the type of sealing material used in the vent 100, the contents of the container, or the brand of the container.

In some embodiments, a cord or lanyard (not shown) may be coupled to the vent 100. One end of the lanyard may be positioned around the channel 11, while another end of the lanyard may be coupled to a surface of the container. The lanyard tethers or retains the vent 100 to the container to avoid the vent 100 being lost or misplaced. The lanyard may be uncoupled from either the vent 100 or the container in order to move the vent 100 away from the container. The lanyard may also be color coded in order to provide similar identifying information as the colored band.

Large sealing areas of the poppets 6, 27 result in larger forces from the springs 15, 19 for a given pressure, causing increased contact with the seals 5, 29 and therefore better sealing. In a nominal or steady state condition, the springs 15, 19 have a nominal length and the pressure poppet 6 contacts the seals 5, 29. Each of the seals 5, 29 may have a large cross section and a low durometer. Large cross section/low durometer seals are more compressible than seals with larger durometers, and provide a large sealing area, which prevents fluid from exiting or entering the container while the seals are under pressure (i.e., contacted by the pressure poppet 6).

Coupling the vent 100 to the container substantially isolates the internal pressure of the container from a pressure of the ambient environment. When the internal and ambient pressures are approximately equivalent (i.e., within a predetermined tolerance of one another), the pressure poppet 6 and the vacuum poppet 27 are in a rest or steady state position (FIG. 3). As environmental factors (e.g., temperature) change, the difference between the ambient pressure and the internal pressure of the container can change, and the vent 100 may avoid expansion or contraction of the container.

When the internal pressure exceeds the ambient pressure, the pressure poppet 6 moves in order to vent higher pressure fluid within the container. Pressure builds within the container and applies a force to the internal face of the pressure poppet 6 (i.e., the face proximate the lower portion 104). The pressure poppet 6 and the vacuum poppet 27 move along the vacuum pin 17 toward the upper portion 108 when the force exceeds the combined biasing force exerted by the ambient pressure and the conical spring 15. The pressure poppet 6 moves away from the seals 5, 29, allowing pressurized fluid flow from the container, between the first seal 5 and the pressure poppet 6, and through circumferential flow paths 14 of the windows 9 to the ambient environment. The barrier 21 blocks liquid (e.g., water) or other debris from falling into the container when a flow path between the environment and the container is open. The lip 22 protects the first seal 5 from the impingement of fluid (e.g., water jets) and external debris.

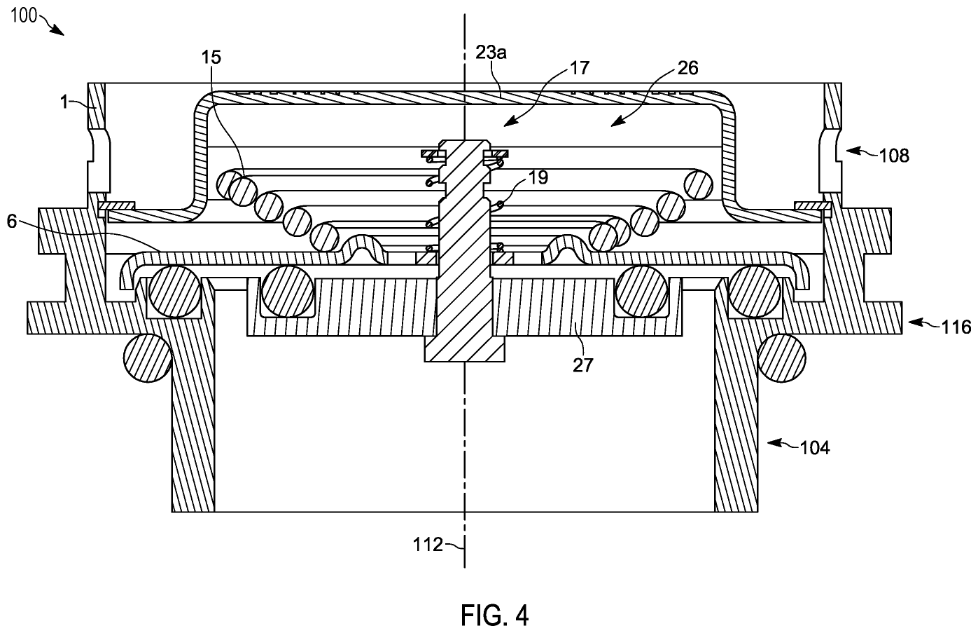

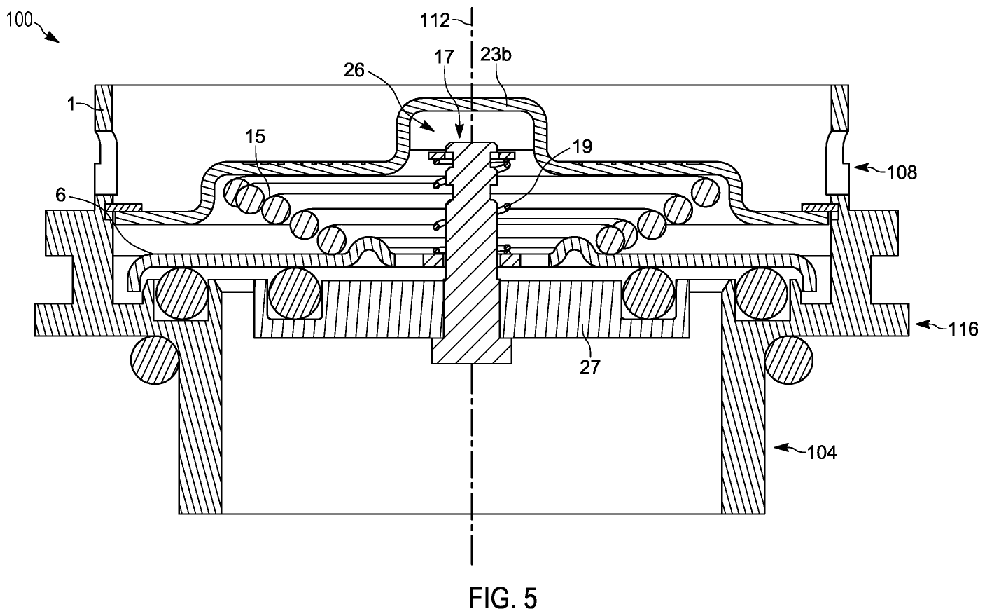

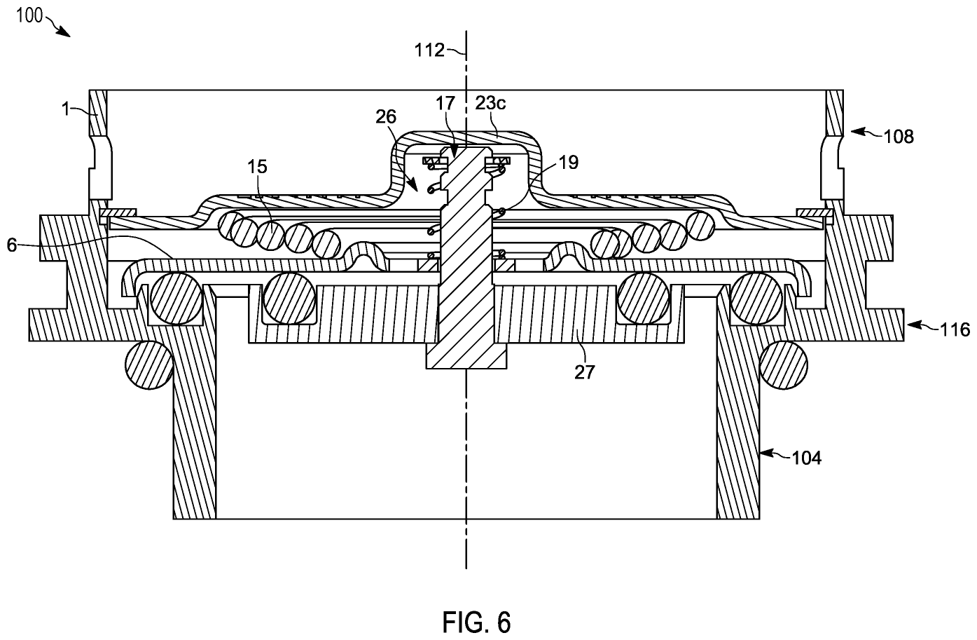

The vent 100 can be configured in different ways, depending on the desired venting pressure differential. In some embodiments, the cover 23 can include a label on an upper surface 24 (FIG. 1) that indicates the venting pressure differential for the vent 100. In some exemplary embodiments (FIGS. 4-6), the venting pressure differential of the pressure poppet 6 (i.e., the positive pressure difference between the internal chamber and the ambient environment) can be 3 pounds per square inch (psi) (FIG. 4), 5 psi (FIG. 5), or 7 psi (FIG. 6). One cover 23a-23c may be replaced with another cover 23a-23c as desired, and it is not necessary use other equipment to test and verify the pressure differential of the vent 100. This may permit a user to adjust the pressure differential of the vent 100, and may simplify production by streamlining assembly and reducing the need to carry a large inventory of vents for various pressure differentials.

The venting pressure differential is primarily determined by the geometry of each cover 23a-23c and the stiffness of the pressure spring 15. In each embodiment, the relative distance between the seat 25 of the respective cover 23a-23c and the pressure poppet 6 in the steady state position affects the compression of the pressure spring 15 and therefore the biasing force exerted on the pressure poppet 6. FIGS. 4-6 illustrate various exemplary configurations in which the seat 25 is positioned at different heights in relation to the pressure poppet 6 in the steady state position (e.g., the seat 25 is furthest from the pressure poppet 6 in the 3 psi vent 100 (i.e., with cover 23a), and is closest to the pressure poppet 6 in the 7 psi vent 100 (i.e., with cover 23c). Positioning the seat 25 closer to the pressure poppet 6 creates more pre-bias in the conical spring 15, which increases the vent pressure.

The pressure spring 15 is compressed as the pressure poppet 6 moves toward the cover 23. In the illustrated embodiment, the pressure spring 15 is a conical coil spring that has a lower spring rate than a similarly sized helical spring. The conical spring 15 also includes a lesser height than a helical spring with a similar spring rate, which assists in minimizing the height of the vent 100. The containers may be stacked on top of one another, and a shorter vent 100 reduces the chances that the vent 100 becomes damaged while trying to move the containers. Minimizing the height of the vent 100 provides a compact product and the vent 100 also maximizes pressure sealing and flow areas. The conical spring 15 can be compressed to flat, which maximizes the travel height of the pressure poppet 6, and therefore the flow area of the vent 100 (particularly in relation to a high rate spring or a non-conical spring). The conical spring 15 also reduces errors (e.g., discharge pressure setting errors) due to manufacturing tolerances.

Conversely, when the ambient pressure exceeds the internal pressure, the vacuum poppet 27 moves in order to allow fluid to flow into the container. A negative pressure differential between the internal chamber and the ambient pressure may cause the ambient force to be greater than the internal force. The vacuum poppet 27 compresses the spring 19 and moves toward the lower portion 104 when the ambient force exceeds the combined biasing force exerted by the internal force and the vacuum spring 19. The vacuum poppet 27 moves away from the pressure poppet 6 so that the second seal 29 is no longer pressed against the pressure poppet 6. Air flows from the environment through circumferential flow paths 14 of the windows 9 (FIG. 2), through the outer through hole 20, between the pressure poppet 6 and seal 29, and into the container. The spring 19 moves the second seal 29 back into engagement with the pressure poppet 6 after the internal pressure and the ambient pressure reach equilibrium.

In some applications, containers may not experience both large positive pressure differentials and large negative pressure differentials. The vent 100 may be configured to allow for only pressure venting or only vacuum venting in situations where venting in both directions is not required.

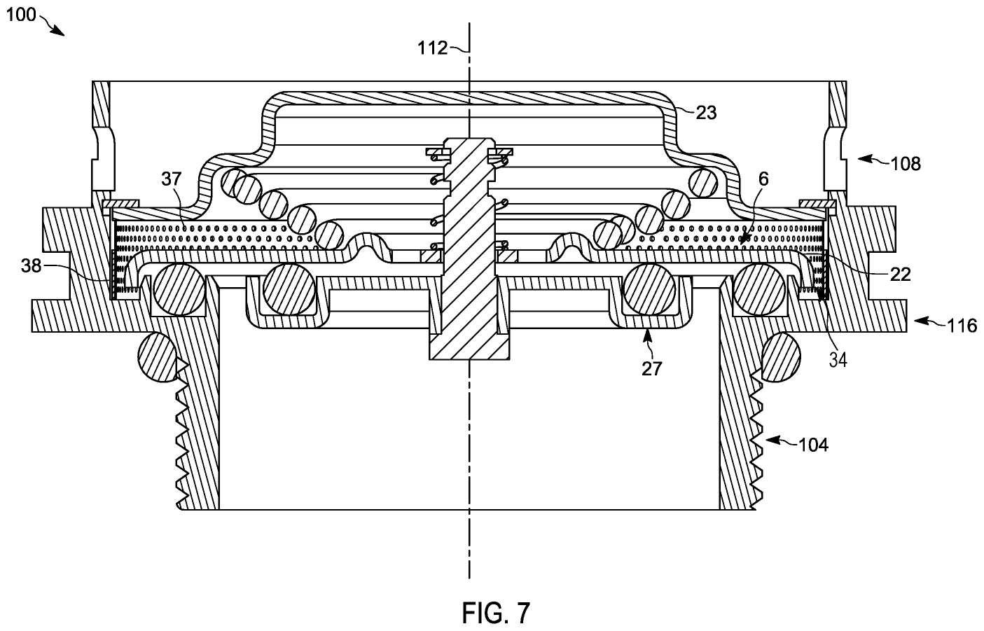

As shown in FIG. 7, some embodiments of the vent 100 include a screen 37. A space 34 is positioned between the lip 22 of the pressure poppet 6 and an internal wall 38 of the vent 100. A user can disassemble the vent 100 (e.g., by removing the cover 23), and position the screen 37 within the vent 100. Positioning the screen 37 within the vent 100 (as opposed to around an external surface of the vent 100) limits the risk of displacing or damaging the screen 37. The space 34 between the pressure poppet and the internal wall 38 protects the screen 37 from damage, which protects against hazardous operating conditions. The space 34 is also external to both of the poppets 6, 27, protecting the screen 37 from contact with the contents of the container (e.g., the closed poppets 6, 27 prevent liquid in the container from splashing against the screen 37). Positioning the screen 37 away from the container opening also limits the contents of the container from contacting the screen 37 and creating blockages in the flow path. The ability to easily disassemble the vent 100 allows a user to interchange different types of screens without complex equipment.

In some embodiments, the screen 37 is a flame arrestor, which is a permeable barrier between the windows 9 (FIG. 2) and the container. The flame arrestor is made from metal mesh or perforated sheet metal. Passage or hole sizes of the flame arrestor are controlled to prevent the transmission of external flames to inside of the container, thereby inhibiting ignition of the contents of the container.

In other embodiments, the screen 37 is an insect screen, which is a permeable barrier that blocks insects, or similar animals, from accessing an internal part of the vent 100 and to the container. For example, the insect screens 37 may be used on containers containing sweet substances that attract insects.

In some embodiments, the vent 100 may include a desiccant breather (not shown). The desiccant breather may be mounted on a first surface 12 and a second surface 13 along an outer diameter of the vent 100 (FIG. 2). The first surface 12 and the second surface 13 are disposed above and below the circumferential flow paths 14, so that the flow of gas or vapor into or out of the vent 100 passes through the desiccant breather. Moisture in the gas or vapor is filtered by the desiccant breather in order to control the moisture level within the container. In some embodiments, the desiccant breather includes a low profile and does not extend above an upper end of the vent 100. The low profile enables the containers to be stacked without damaging the desiccant breathers, and allows flow through the desiccant breather without requiring the breather to be positioned in a particular orientation.

FIG. 8 illustrates a vent 500 according to another embodiment. The vent 500 is similar to the vent 100 described above, and similar features are identified with similar reference numbers, plus 500. Some of the differences between vent 100 and vent 500 are described below; however, it is understand that one or more aspects of vent 100 can be incorporated into vent 500, and vice versa.

The vent 500 includes a vacuum pin 517 engaging a poppet 527. In the illustrated embodiment, the vacuum pin 517 is riveted through a through hole 550 of the poppet 527, thereby providing a leak-tight seal. In addition, a retaining clip 532 is coupled to the vacuum pin 517 and retains a vacuum spring 519, and a spacer 530 is positioned between the retaining clip 532 and the vacuum spring 519. The spacer 530 determines the compression of the vacuum spring 519 and therefore determines the poppet pressure settings. Accordingly, pressure setting can be adjusted by replacing the spacer 530 with a spacer having a different thickness, rather than changing a position of the retaining clip 532. In some embodiments, the biasing force of the vacuum spring 519 is set to be greater than the product of the combined mass of the poppet 527 and the vacuum pin 517 multiplied by the expected shock load (e.g., caused by movement of a container over a rough road) in order to reduce the likelihood that the vent will open inadvertently.

In the illustrated embodiment, the vacuum pin 517 includes a shoulder 534 that engages the spacer 530 and/or retaining clip 532 when the vacuum spring 519 is compressed to a predetermined length. The shoulder 534 therefore prevents the vacuum spring 519 from being compressed to solid (e.g., during assembly).

Also, as shown in FIG. 8, in some embodiments a baffle 200 can be coupled to the vent 500. In the illustrated embodiment, the baffle 200 is coupled to a lower portion 604, adjacent an end of the vent 500 that is positioned within a container (not shown). The baffle 200 may inhibit sticky or viscous substances from contacting components of the vent 500, which could interfere with operation of the vent 500. In the illustrated embodiment, the baffle 200 is a cup-shaped structure that includes openings 202 in a side wall to permit fluid flow. An edge of the baffle 200 includes a flange 204. A retainer 206 may be coupled to the lower portion 604 (for example, by engaging a groove 606 positioned in an inner surface of the lower portion 604), and the retainer 206 engages the flange 204 of the baffle 200. In addition, an inner surface 210 of the baffle 200 is inclined away from a center of the baffle 200 in order to inhibit the build-up of sticky or viscous substances inside the baffle 200.

It is understood that the vent 100, 500 may be provided in a cover member separate from and attached to a cap body as described and shown in U.S. Provisional Patent Application No. 62/786,791, filed Dec. 31, 2018, the entire contents of which are hereby incorporated by reference.

The embodiment(s) described above and illustrated in the figures are presented by way of example only and are not intended as a limitation upon the concepts and principles of the present disclosure. As such, it will be appreciated that variations and modifications to the elements and their configuration and/or arrangement exist within the spirit and scope of one or more independent aspects as described.

What is claimed is:

1. A vent for selectively sealing an opening of an enclosed chamber, the vent comprising:
a body configured to be coupled to the enclosed chamber;
a first poppet disposed within the body and biased by a first biasing member, the first poppet including a first surface;
a second poppet disposed within the body and including a second surface, the second poppet biased toward the first poppet such that the second surface is biased toward engaging the first surface; and
a face seal positioned between the first surface and the second surface.

2. The vent of claim 1, wherein the first biasing member is a conical spring that is compressible to a substantially flat shape.

3. The vent of claim 1, further comprising a cord coupled to an outer surface of the body and configured to be coupled to the enclosed chamber.

4. The vent of claim 1, wherein first poppet biased toward a surface of the body such that the first surface is biased toward engaging the surface of the body, further comprising a second face seal positioned between the first surface and the body.

5. The vent of claim 4, wherein the second face seal has a larger outer dimension than the first face seal and a larger outer diameter than the first biasing member.

6. The vent of claim 1, wherein the first poppet has an opening positioned proximate an axis of the first biasing member, the second poppet aligned to cover the opening while the second surface engages the first surface.

7. The vent of claim 1, wherein the face seal engages the first surface and the second surface while the difference in pressure of the enclosed chamber relative to the ambient environment is above a predetermined amount, and further comprising a second face seal positioned between the first poppet and the body, the second face seal engaging the body and the first poppet while a difference in pressure of the enclosed chamber relative to an ambient environment is below a predetermined amount.

8. The vent of claim 1, wherein an internal surface of the body is coated with at least one of a hydrophobic material and an oleophobic material.

9. The vent of claim 1, further comprising a permeable barrier disposed within the body adjacent the first poppet, the permeable barrier configured to limit entry into the enclosed chamber regardless of a position of the poppets.

10. The vent of claim 1, wherein the first poppet is configured to move away from the enclosed chamber as the result of a positive pressure differential between the enclosed chamber and an ambient environment, and the second poppet is configured to move toward the enclosed chamber as the result of a negative pressure differential between the enclosed chamber and the ambient environment.

11. The vent of claim 1, wherein the second poppet is biased by a second biasing member, the second biasing member secured against the second poppet by a retaining member, a position of the retaining member being adjustable between discrete positions to modify a biasing force of the second biasing member.

12. The vent of claim 1, wherein the second poppet is biased by a second biasing member, the second biasing member secured against the second poppet by a spacer, wherein substituting the spacer with another spacer having a different thickness modifies the biasing force of the second biasing member.

13. The vent of claim 1, further comprising a cap coupled to the body, the first biasing member disposed between the cap and the first poppet.

14. A vent for selectively sealing an opening of an enclosed chamber, the vent comprising:
a body having an upper portion and a lower portion;
a cap including a seating feature having a first dimension, the cap removably coupled to the body;
a poppet disposed within the body; and
a biasing member engaging the seating feature and exerting a biasing force on the poppet.

15. The vent of claim 14, wherein the poppet is a first poppet and the biasing member is a first biasing member, the vent further comprising a second poppet disposed within the body and biased by a second biasing member toward the first poppet.

16. The vent of claim 15, wherein the first poppet is configured to move away from the enclosed chamber as the result of a positive pressure differential between the enclosed chamber and an ambient environment, and the second poppet is configured to move toward the enclosed chamber as the result of a negative pressure differential between the enclosed chamber and the ambient environment.

17. The vent of claim 14, wherein the biasing member is a conical spring that is compressible to a substantially flat shape.

18. The vent of claim 14, further comprising
a first seal positioned between the body and the first poppet, the first seal engaging the body and the first poppet when a difference in pressure of the enclosed chamber relative to an ambient environment is below a predetermined amount; and
a second seal positioned between the first poppet and the second poppet, the second seal engaging the first poppet and the second poppet when the difference in pressure of the enclosed chamber relative to the ambient environment is above a predetermined amount.

19. The vent of claim 14, wherein the cap is one of a first cap and a second cap, the first cap including a seating feature having a first dimension, the second cap including a seating feature having a second dimension, wherein positioning the biasing member in the seating feature of the second cap causes the spring to exert a different biasing force on the poppet than if the biasing member is positioned in the first cap.

20. The vent of claim 14, wherein an internal surface of the body is coated with at least one of a hydrophobic material and an oleophobic material.

21. The vent of claim 14, further comprising a permeable barrier disposed within the body adjacent the first poppet, the permeable barrier configured to limit entry into the enclosed chamber regardless of a position of the poppets.

22. A vent for selectively sealing an opening of an enclosed chamber, the vent comprising:
a body configured to be coupled to the enclosed chamber;
a poppet disposed within the body, the poppet moveable relative to the body in response to a fluid pressure within the enclosed chamber; and
a conical spring coupled to the poppet and providing a biasing force to the poppet, the conical spring configured to compress as the poppet moves.

23. The vent of claim 22, further comprising a cap coupled to the body, a shape of the cap defining a pre-bias of the conical spring, the pre-bias determining a magnitude of a pressure differential required to move the poppet.

24. The vent of claim 22, wherein the poppet is a first poppet, the vent further comprising a second poppet disposed within the body and coupled to a biasing member, the first poppet biased in a direction opposite the second poppet.

25. The vent of claim 22, wherein the conical spring is compressible to a substantially flat shape.
